(19) United States
(12) Patent Application Publication
(10) Pub. No.: US 2006/0060023 A1
(43) Pub. Date: Mar. 23, 2006

(54) Parking brake apparatus and operating handle for parking brake apparatus

(75) Inventors: Fumikage Yamanaka, Saitama (JP); Naoto Shibui, Saitama (JP); Satoru Masuda, Kanagawa (JP); Shingo Hori, Kanagawa (JP); Hiroshi Kawaguchi, Kanagawa (JP); Daisuke Murata, Kanagawa (JP)

Correspondence Address: TAKEUCHI & KUBOTERA, LLP;Suite 202, 200 Daingerfield Road, Alexandria, VA, 22314, US

(73) Assignees: HONDA GIKEN KOGYO KABUSHIKI KAISHA; OTSUKA KOKI KABUSHIKI KAISHA

(21) Appl. No.: 11/231,973

(22) Filed: Sep. 22, 2005

(30) Foreign Application Priority Data
Aug. 3, 2005 (JP) 2005-225457
Aug. 3, 2005 (JP) 2005-225458
Sep. 22, 2004 (JP) 2004-276112
Sep. 22, 2004 (JP) 2004-276113
Sep. 22, 2004 (JP) 2004-276114
Sep. 22, 2004 (JP) 2004-276115

(51) Int. Cl. G05G 1/00

(52) U.S. Cl. 74/503

(57) ABSTRACT

A parking brake apparatus includes: an operating handle including an operating pushbutton; a base bracket including a ratchet plate having a ratchet; a brake cable for actuating a brake when the operating handle is pulled along a longitudinal direction of the base bracket; and a shaft retained in the base bracket and having a base end part fixed to the operating handle and a nose part connected to the brake cable. The shaft includes a seizing and releasing mechanism connected to the brake cable and having a seizing pawl for seizing and releasing the ratchet, and a releasing mechanism connected to the operating handle and having a release pawl for reorienting the seizing pawl seizing the ratchet through the operating pushbutton to release the seizing pawl from the ratchet.

### BACKGROUND OF THE INVENTION AND RELATED ART STATEMENT

The present invention relates to a parking brake apparatus in which a base bracket holds a shaft having a base end part fixed to an operating handle and a nose part connected to a brake cable, so that when the operating handle is pulled in a longitudinal direction of the base bracket, the brake cable is pulled to actuate a brake. The present invention also relates to a parking brake apparatus comprising a hollow shaft having a base end part fixed to an operating handle and a nose part connected to a brake cable and a base bracket for accommodating the shaft, so that when the operating handle is pulled to draw out the shaft from the base bracket, the brake cable is pulled to actuate a brake. The present invention further relates to an operating handle provided in a parking brake apparatus for drawing out a shaft accommodated in a base bracket from the base bracket to a fixing position to actuate a brake, and for returning the shaft to the base bracket from the fixing position without turning the shaft to release the brake.

FIG. 14 shows a conventional parking brake apparatus. In a parking brake apparatus 100, when an operating handle 101 is pulled, a brake cable 102 is pulled to actuate a brake. The parking brake apparatus 100 comprises an operating lever 104 supported to be freely slide in a guide member 103; an operating handle 101 mounted to a base end of the operating lever 104; and a brake cable 102 connected to a nose part of the operating lever 104. In the operating lever 104, a ratchet (not shown) is disposed, and a nail (not shown) is provided in the guide member 103 for engaging with the ratchet.

In the parking brake apparatus 100, when the operating lever 104 is pulled through the operating handle 101, the brake cable 102 is pulled to generate a braking force of the brake. In a state that the operating lever 104 is pulled, when the operating handle 101 is released, the nail engages with the ratchet, so that the operating lever 104 is locked to hold the braking force of the brake. When the operating lever 104 is turned, the nail is disengaged from the ratchet, and the operating lever 104 returns to an original position with a tension of the brake cable 102, so that the braking force is released.

Such a parking brake apparatus is generally provided on a front side of a driver seat in a vehicle. In this state, the operating handle and a part of the operating lever protrude toward a driver. Accordingly, when the brake is actuated, they can be an obstruction for a driving operation. In addition, in the protruding state, it is difficult to walk through between a driver seat and a passenger seat. Further, it is necessary to provide a space for turning the operating handle, thereby making it difficult to design a layout of the vehicle.

When a hand or foot of a driver contacts with the operating handle, the brake may be accidentally released. When the brake is released, the latch formed in the operating lever slides against the nail, thereby wearing the latch and the nail.

Accordingly, it has been desired to develop a parking brake apparatus in which the brake can be released without turning a handle and a space for turning the handle.

In view of the problems mentioned above, an object of the present invention is to provide a parking brake apparatus with a small size and capable of reducing the space requirement. Another object of the present invention is to provide a parking brake apparatus with improved safety and maintenance operation. A further object of the present invention is to provide an operating handle of a parking brake apparatus with a simple configuration without a large space for turning a handle.

### SUMMARY OF THE INVENTION

In order to achieve the above objects, according to a first aspect of the present invention, a parking brake apparatus comprises an operating handle including an operating pushbutton; a base bracket including a ratchet plate having a ratchet; a brake cable for actuating a brake when the operating handle is pulled along a longitudinal direction of the base bracket; and a shaft retained in the base bracket and having a base end part fixed to the operating handle and a nose part connected to the brake cable. The shaft includes a seizing and releasing mechanism having a seizing pawl for seizing and releasing the ratchet and connected to the brake cable, and a releasing mechanism connected to the operating handle and having a release pawl for reorienting the seizing pawl seized with the ratchet through the operating pushbutton to release the seizing pawl from the ratchet.

According to a second aspect of the present invention, in the parking brake apparatus according to the first aspect, the seizing and releasing mechanism further includes an energizing member for applying an energizing force to the seizing pawl in a direction that the seizing pawl seizes the ratchet.

According to a third aspect of the present invention, in the parking brake apparatus according to the first aspect, the releasing mechanism further includes a release rod connected to the operating pushbutton for moving the release pawl to reorient the seizing pawl, so that the release rod is moved to reorient the seizing pawl for releasing the seizing pawl from the ratchet when the pushbutton is operated in a state that the operating handle is pulled.

According to a fourth aspect of the present invention, in the parking brake apparatus according to the first aspect, the seizing and releasing mechanism further includes a pull bracket extending in a longitudinal direction of the shaft and connected to the brake cable, a pivot pin fixed to the pull bracket for supporting the seizing pawl to be rotatable, and an energizing member for applying an energizing force to the seizing pawl in a direction that the seizing pawl seizes the ratchet. Further, the releasing mechanism includes a release rod connected to the operating pushbutton, and a fixing member extending in the longitudinal direction of the shaft and having one end part fixed to the release pawl and the other end part connected to the release rod, so that the release rod slides by a prescribed amount. The fixing member is arranged to be able to slide in accompany with the pushbutton when the release rod slides by the prescribed amount, so that the release pawl reorients the seizing pawl to release the seizing pawl from the ratchet when the fixing member moves.

According to a fifth aspect of the present invention, the parking brake apparatus according to the first aspect further comprises a pivot pin situated close to the nose part of the shaft when the brake is released; a switch link rotatably supported on the pivot pin to be capable of abutting against the shaft, and a switch to be turned on and off with the switch link. The switch link has a first length from the pivot pin to a first portion thereof abutting against the nose part greater than a second length from the pivot pin to a second portion thereof contacting the switch when the brake is released, so that the switch is operated with a pressing force smaller than a pressing force of the shaft.

According to a sixth aspect of the present invention, in the parking brake apparatus according to the first aspect, the base bracket includes two bracket members jointed together; a cable introducing slit extending in the longitudinal direction of the base bracket at an end part thereof closer to the nose part of the shaft; and a fixing part for fixing the bracket members.

According to a seventh aspect of the present invention, in the parking brake apparatus according to the second aspect, the seizing pawl includes a released position maintaining part supported on the release pawl for maintaining the seizing pawl at a released position when the seizing pawl is released from the ratchet.

According to an eighth aspect of the present invention, in the parking brake apparatus according to the seventh aspect, the ratchet plate includes a position canceling part for reorienting the seizing pawl in a direction that the released position maintaining part moves away from the release pawl to release the seizing pawl from the released position.

According to a ninth aspect of the present invention, a parking brake apparatus comprises: an operating handle including an operating pushbutton; a base bracket including a ratchet plate extending in a longitudinal direction thereof and having a ratchet; a brake cable for actuating a brake when the operating handle is pulled along the longitudinal direction of the base bracket; a shaft with a hollow body retained in the base bracket and having a base end part fixed to the operating handle and a nose part connected to the brake cable; a seizing and releasing mechanism disposed in the hollow body and connected to the brake cable for seizing and releasing the ratchet to fix the shaft; a releasing mechanism disposed in the hollow body and connected to the operating handle for releasing the seizing and releasing mechanism from the ratchet; and a guide bushing fixed to the seizing and releasing mechanism for holding the shaft so that the shaft moves smoothly in the base bracket, and for releasing the shaft in a direction when the shaft is pushed into the base bracket in the direction in a state that the shaft is fixed.

According to a tenth aspect of the present invention, in the parking brake apparatus according to the ninth aspect, the seizing and releasing mechanism further includes a pull bracket extending inside the shaft in the longitudinal direction, arranged to be movable in the longitudinal direction, and having a rear end part connected to the brake cable; a seizing pawl rotatably supported on a pivot pin fixed to the pull bracket and facing outside the shaft for seizing and releasing the ratchet; and an energizing member for applying an energizing force to the seizing pawl so that the seizing pawl seizes the ratchet. Further, the releasing mechanism includes a release pawl for moving the seizing pawl against the energizing force, so that the seizing pawl is released from the ratchet.

According to an eleventh aspect of the present invention, in the parking brake apparatus according to the ninth aspect, the seizing and releasing mechanism further includes a coil spring connected to the shaft and extending and being compressed in accompany with the shaft, so that the shaft slides in a prescribed range in the longitudinal direction of the base bracket. The coil spring is compressed to absorb a force and return the shaft when the force is applied to the shaft to be pushed into the base bracket in a state that the seizing and releasing mechanism seizes the ratchet and the shaft is fixed.

According to a twelfth aspect of the present invention, an operating handle for a parking brake apparatus comprises: a base bracket; a shaft accommodated in the base bracket; connecting means disposed in the shaft for connecting a brake cable; releasing means disposed in the shaft for releasing the shaft from a fixed position where the shaft is drawn out of the base bracket to actuate a brake so that the shaft returns into the base bracket to release the brake without turning the shaft; a shaft plate fixed to a base part of the shaft; a link rotatably supported on the shaft plate with a pivot pin and having one end part connected to the releasing means; an operating pushbutton connected to the other end part of the link; and a handle core for accommodating the shaft plate, the link, and the operating pushbutton at a side of the link, so that the releasing means is operated through the link to release the shaft when the operating pushbutton is operated.

According to a thirteenth aspect of the present invention, in the operating handle according to the twelfth aspect, the operating pushbutton includes an arm extending into the handle core and having a bent dropping-off prevention part. The shaft plate includes a seizing part for seizing the dropping-off prevention part to prevent the operating pushbutton from coming off from the handle core.

The respective aspects of the present invention described above have the following effects. In the parking brake apparatus of the first aspect, by manually pulling the operating handle fixed to the base end part side of the shaft held by the base bracket so as to be enclosed thereby in the longitudinal direction of the base bracket, the brake cable connected to the nose part side is pulled to actuate the brake.

In the direction of the shaft pulled in the longitudinal direction, the ratchet plate fixed to the base bracket is located, and when the seizing pawl in the seizing and releasing mechanism reaches the portion of the ratchet formed in the ratchet plate, the seizing pawl can seize the ratchet.

After pulling the operating handle to a position where the braking force of the brake is sufficiently applied, releasing the handgrip will cause the brake cable to be slightly pulled back, so that the shaft returns by the corresponding amount. By this return, the seizing pawl will seize the ratchet, resulting in the position of the shaft being fixed. Thereby, the brake is kept in the actuated state.

When the brake is de-actuated, the operating pushbutton provided in the operating handle is operated to operate the releasing mechanism for causing the release pawl to reorient the seizing pawl for releasing it from the state of seizing the ratchet. When the seizing pawl is released from the state of seizing the ratchet, the shaft is pulled back by the brake cable. Accordingly, when the shaft returns as it is pulled, the brake is de-actuated.

In the parking brake apparatus of the second aspect, the ratchet plate is provided to extend in the longitudinal direction of the base bracket, and the seizing pawl is swingably pivoted, with the energizing member applying the energizing force in the direction of causing the seizing pawl to seize the ratchet. Thereby, the seizing pawl can reliably seize the ratchet.

In the parking brake apparatus of the third aspect, the operation of pulling the operating handle is carried out. In the state the operation handle is pulled, operating the operating pushbutton will cause the release rod connected to the operating pushbutton to be moved. The movement of the release rod causes the release pawl to be moved for reorienting the seizing pawl. Thereby, the seizing pawl is released from the state of seizing the ratchet.

In the parking brake apparatus of the fourth aspect, with the seizing and releasing mechanism, the brake cable is directly connected to the pull bracket on the nose part of the shaft. The seizing pawl is swingably pivoted by the pivot pin fixed to the pull bracket. The release pawl in the releasing mechanism is fixed on one end part of the fixing member extending in the longitudinal direction of the shaft. On the other end part of the fixing member, the release rod connected to the operating pushbutton in the operating handle is connected to be slidable by a prescribed amount. Thereby, the fixing member can be moved, being interlocked with the operation of the operating pushbutton in the state that the release rod slides by the prescribed amount. Accordingly, the release pawl can be moved for reorienting the seizing pawl to release it from the state of seizing the said ratchet.

The release rod is connected to the fixing member to be slidable by the prescribed amount. Accordingly, when the operating pushbutton is accidentally depressed, the release rod slides within the prescribed amount, and the fixing member does not move. Therefore, the release pawl does not be move, and the seizing pawl is not reoriented, whereby the brake is not accidentally released.

In the parking brake apparatus of the fifth aspect, the swingable switch link may be provided on the nose part of the shaft when the brake is de-actuated, so that the switch is turned ON/OFF through the switch link. In this case, the pressing force of the shaft is reduced with the switch link, and the pressing force suited for the type of the switch can be obtained. Thereby, the state of the brake can be reliably detected, which allows the state of the brake to be reported to the operator.

In the parking brake apparatus of the sixth aspect, the brake cable can be easily introduced into the base bracket through the cable introducing slit, and the connection can be performed easily. After the brake cable is connected, the two bracket members can be fixed to each other by fixing the fixing part with a bolt and a nut.

In the parking brake apparatus of the seventh aspect, by manually pulling the operating handle fixed to the base end part of the shaft held by the base bracket so as to be enclosed thereby in the direction of the base bracket, the brake cable connected on the nose part is pulled to actuate the brake.

In the direction of the shaft is pulled in the longitudinal direction, the ratchet plate fixed to the base bracket is located. When the seizing pawl in the seizing and releasing mechanism reaches the portion of the ratchet formed in the ratchet plate, the seizing pawl can reliably seize the ratchet, because it is subjected to an energizing force in the direction of seizing the ratchet from the energizing member.

After pulling the operating handle to a position where the braking force of the brake is sufficiently applied, releasing the operating handle will cause the brake cable to be slightly pulled back. Accordingly, the shaft returns by the corresponding amount, and the seizing pawl seizes the ratchet, resulting in the position of the shaft being fixed. Thereby, the brake is kept in the actuated state.

When the brake is de-actuated, the operating pushbutton in the operating handle is operated to operate the releasing mechanism for causing the release pawl to reorient the seizing pawl for releasing it from the ratchet. Even if the operating pushbutton is operated without the operating handle being pulled, the releasing mechanism is not operated, thus even if the operating pushbutton is accidentally operated, the brake is not de-actuated.

In the parking brake apparatus of the eighth aspect, the seizing pawl released from the state of seizing the ratchet by the release pawl is in the position released from the state of seizing the release pawl. The released position is maintained by the released position maintaining part abutting against the release pawl and supported thereon by the energizing force of the energizing member.

When the seizing pawl is released from the state of seizing the ratchet, the shaft is pulled back by the brake cable. Accordingly, when the shaft returns as it is pulled, the brake is de-actuated. When the shaft is pulled back, the seizing pawl is reoriented in the direction of separating the released position maintaining part from the release pawl by the position canceling part, thus the shaft is pulled back smoothly.

In the parking brake apparatus of the ninth aspect, by manually pulling the operating handle fixed to the base end part of the hollow shaft accommodated in the base bracket in the longitudinal direction of the base bracket, the brake cable connected on the nose part is pulled to actuate the brake. The shaft can be pulled without being directly contacting with the base bracket by the guide bushing loaded to the outside of the nose part. By manufacturing the guide bushing with a material having a low coefficient of friction against the base bracket, the shaft can be smoothly moved in the base bracket.

In the direction that the shaft is pulled in the longitudinal direction, the ratchet formed in the ratchet plate fixed to the base bracket faces the inside of the base bracket, and the seizing and releasing mechanism can seize the ratchet. By the seizing and releasing mechanism seizing the ratchet, the position of the shaft can be fixed.

After the operating handle is pulled to a position where the braking force of the brake is sufficiently applied, releasing the handgrip will cause the brake cable to be slightly pulled back, thus the shaft returns by the corresponding amount. By this return, the seizing pawl will seize the ratchet, resulting in the position of the shaft being fixed. Thereby, the brake is kept in the actuated state.

At this time, because the guide bushing is fixed in the position, the shaft held by the guide bushing is also fixed in the position. For example, when a force in the direction of pushing the shaft into the base bracket is applied to the operating handle, the shaft can get away in the direction of the force being applied.

When the brake is de-actuated, the operating pushbutton provided in the operating handle is operated to operate the releasing mechanism for releasing the seizing and releasing mechanism from the state of seizing the ratchet. When the seizing and releasing mechanism is released from the state of seizing the ratchet, the shaft is pulled back by the brake cable. Accordingly, when the shaft returns as it is pulled, the brake is de-actuated.

In the parking brake apparatus of the tenth aspect, the brake cable is connected to the rear end part of the pull bracket in the seizing and releasing mechanism. Accordingly, when the shaft is pulled by the operating handle, the pull bracket also moves together with the shaft, thus the brake cable is also pulled.

With the seizing and releasing mechanism, the seizing pawl seizes and releases the ratchet facing the outside of the shaft. The seizing pawl is subjected to an energizing force in the direction of seizing the ratchet by the energizing member. Accordingly, when it reaches the portion where the ratchet is formed, it can reliably seize the ratchet.

With the releasing mechanism, the release pawl changes the position of the seizing pawl in the state of seizing the ratchet against the energizing force to reliably release it from the state of seizing the ratchet.

In the parking brake apparatus of the eleventh aspect, when a force in the direction of pushing the shaft into the base bracket is applied as mentioned above, the shaft away in the same direction can returns to the original position with the coil spring.

In the operating handle of the twelfth aspect, the handle core is fixed to the base part of the shaft. Accordingly, by gripping and pulling it with a hand, the shaft can be drawn out of the base bracket. The brake cable is connected to the connecting means disposed inside the shaft, so that the brake cable is pulled together with the shaft. When the shaft is fixed in the position in the state of being drawn out of the base bracket, the brake cable is kept being pulled, thus the brake is kept in the actuated state.

When the state that the shaft is fixed in the position is cancelled with the brake actuated, the operating pushbutton is depressed toward the inside of the handle core without turning the shaft to operate the releasing means. When the operating pushbutton is depressed, the link is turned around the pivot pin pressed by the operating pushbutton.

By this turning of the link, the release rod connected to the link is pulled. Thereby, the releasing means is operated to release the shaft from the state of being fixed in the position. When the fixed state is cancelled, the shaft is pulled by the brake cable through the connecting means. Accordingly, by returning the shaft in accordance with the pulling force, the braking force of the brake can be nullified.

In the operating handle of the thirteenth aspect, the dropping-off prevention part formed in the arm of the operating pushbutton seizes the seizing part of the shaft plate, thus the operating pushbutton is prevented from being dropped off from the handle core.

### BRIEF DESCRIPTION OF THE DRAWINGS

FIG. 1 is a side view illustrating a parking brake apparatus pertaining to one embodiment of the present invention;

FIG. 2 is a sectional view taken on the line D-D in the direction of the arrows in FIG. 1;

FIG. 3 is a sectional view taken on the line I-I in the direction of the arrows in FIG. 1;

FIG. 4 is a plan view illustrating the parking brake apparatus pertaining to one embodiment of the present invention;

FIG. 5 is an explanatory drawing for explaining the brake de-actuating state of the parking brake apparatus pertaining to one embodiment of the present invention;

FIG. 6 is an explanatory drawing for explaining the brake actuating state of the parking brake apparatus pertaining to one embodiment of the present invention;

FIG. 7 is an explanatory drawing for explaining the cushioning function of the parking brake apparatus pertaining to one embodiment of the present invention;

FIG. 8 is an explanatory drawing for explaining the brake de-actuation of the parking brake apparatus pertaining to one embodiment of the present invention;

FIG. 9 is an explanatory drawing for explaining the brake de-actuation of the parking brake apparatus pertaining to one embodiment of the present invention;

FIG. 10 is a schema illustrating the parking brake apparatus loaded with an operating handle pertaining to one embodiment of the present invention;

FIG. 11 is a sectional view taken on the line H-H in the direction of the arrows in FIG. 10 showing the operating handle for the parking brake apparatus;

FIG. 12 is a sectional view taken on the line J-J in the direction of the arrows in FIG. 10 showing the operating handle for the parking brake apparatus;

FIG. 13 is a drawing illustrating the relationship between the shaft plate and the other members; and

FIG. 14 is a perspective side view illustrating an example of the prior art.

### DETAILED DESCRIPTION OF THE PREFERRED EMBODIMENTS

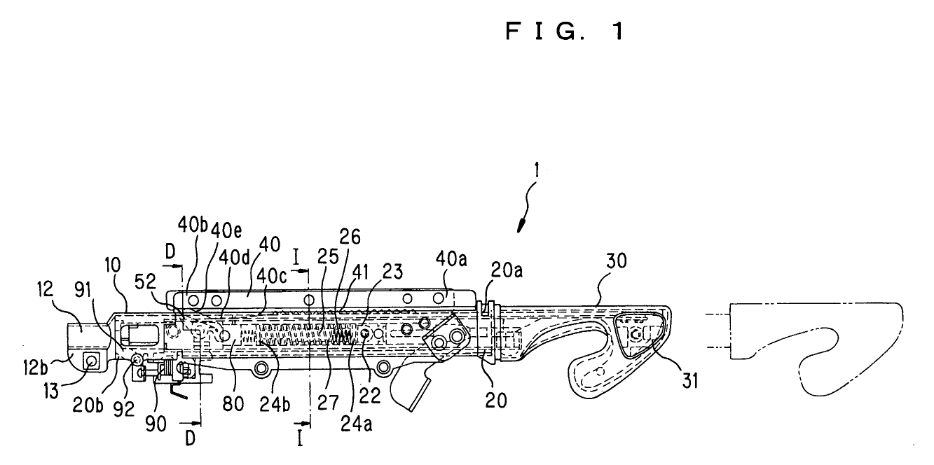

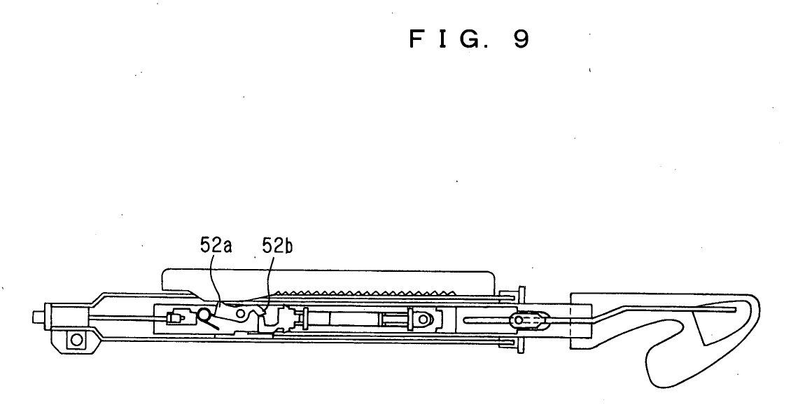

Hereunder, embodiments of the present invention will be described with reference to the drawings. FIG. 1 to FIG. 9 show one embodiment of the present invention.

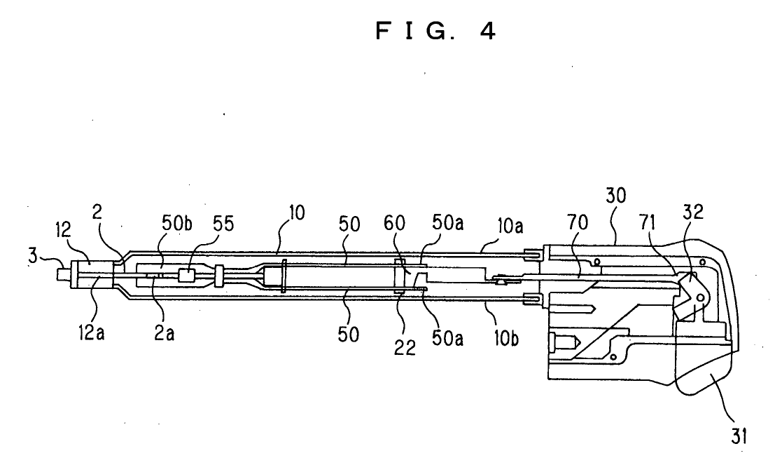

With a parking brake apparatus 1 as shown in FIG. 1, a base bracket 10 holds a shaft 20 so as to enclose it. In other words, the entire hollow shaft 20 is accommodated inside the base bracket 10. The base bracket 10 is made up of two oblong metallic plates formed and jointed to each other, the joint being fixed with rivets 11. The shaft 20 held by the base bracket 10, which an operating handle 30 is fixed on the side of a base end part 20a, and as later described, in a nose part 20b, one end part of a brake cable 2 (see FIG. 4) is connected. The other end part of the brake cable 2 is connected to a brake unit (not shown), and by pulling the operating handle 30 along the longitudinal direction of the base bracket 10, the brake cable 2 is pulled to actuate the brake.

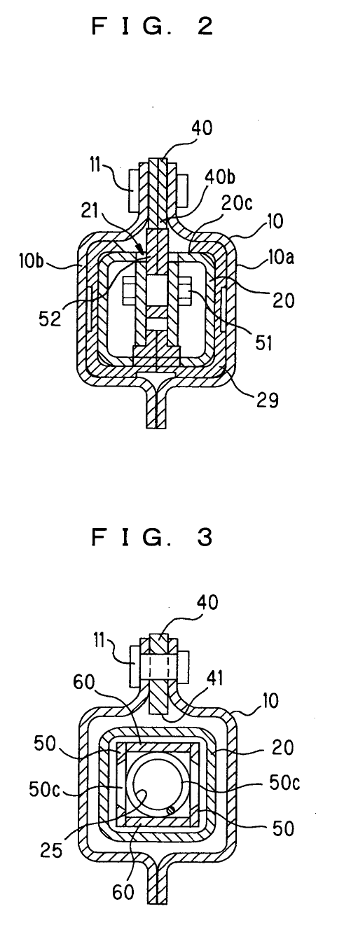

As shown in FIG. 2 and FIG. 3, the section of the base bracket 10 is substantially in the shape of a hollow square, and the internal space extends straight in the longitudinal direction. At the joint on the top side where two bracket members 10a, 10b constituting the base bracket 10 are mutually fixed, an oblong ratchet plate 40 is sandwiched therebetween, being fixed together with the bracket members 10a, 10b by means of said rivets 11. Therefore, the ratchet plate 40 is provided to extend in the longitudinal direction of the base bracket 10. In the top portion of the joint of a rear end part 12 of the base bracket 10, a cable introducing slit 12a which allows the brake cable 2 to be introduced from the outside of the base bracket 10 to the inside thereof is formed. The brake cable 2 introduced through the cable introducing slit 12a can be connected to a rear end part 50b of a pull bracket 50, later described. In the lower portion of the joint, a fixing part 12b for fixing the bracket members 10a, 10b to each other by means of a bolt 13 and a nut (not shown) is formed. Inside of the rear end part 12, the end part of an outer cable 3 which the brake cable 2 is passed through can be accommodated.

On the lower edge along the longitudinal direction of the ratchet plate 40, a ratchet 41 is formed. The ratchet 41 is formed from a point slightly closer to the center than a front end part 40a of the ratchet plate 40 to a point slightly distant from the center toward a rear end part 40b. From the point where the formation of the ratchet 41 is ended in the rear end part 40b, a downward slope part 40c (the position canceling part) which is gently sloped downward toward the rear end part 40b is formed. From the point where the downward slope part 40c is ended, a flat part 40d which has no slope is formed. From the point where the flat part 40d is ended, an upward slope part 40e is formed, extending to the rear end part 40b. The portion of the ratchet plate 40 thus formed that ranges from the rear end part 40b to a part of the ratchet 41 is disposed so as to be faced to the internal space of the base bracket 10.

The shaft 20 is a cylindrical element made of a metal which section is formed in the shape of a hollow square, and from a point slightly closer to the nose part 20b than the center to the nose part 20b on a top surface 20c, a cutout part 21 is formed. The cutout part 21 allows a seizing pawl 52, later described, to get out from or get in into the inside of the shaft 20 to seize or release the ratchet 41, respectively, or butt against the downward slope part 40c or the flat part 40d. In the nose part 20b, a guide bushing 29 is loaded such that it encloses the outer periphery of the shaft 20, excluding the cutout part 21. The guide bushing 29 is protruded from the central part of the bottom of the shaft 20 into the shaft to be fixed to a pair of pull brackets 50.

Thereby, the shaft 20 is accommodated inside of the base bracket 10 without being directly contacted with the base bracket 10. The guide bushing 29 is made of a synthetic resin, or the like, and has a low coefficient of friction between it and the base bracket 10, made of a metal, allowing the shaft 20 to be smoothly moved inside of the base bracket 10. In addition, when the seizing pawl 52 seizes the ratchet 41, the guide bushing 29 is also fixed in position together with the pull brackets 50. At this time, the shaft 20 held by the guide bushing 29 is also fixed in position, however, the shaft 20 is not fixed to the guide bushing 29, thus even when the guide bushing 29 is fixed in position, the shaft 20 can be slid in a first guide hole 50c, while being held by the guide bushing 29, as described later.

Inside of the shaft 20, a seizing and releasing mechanism which can cause said seizing pawl 52 to seize the ratchet 41 for fixing the position of the shaft 20 with respect to the base bracket 10, and a releasing mechanism for releasing the seizing pawl 52 from the state of seizing the ratchet 41 are disposed.

The seizing and releasing mechanism comprises the pair of pull brackets 50 which extend in the longitudinal direction along both sides of the shaft 20; the seizing pawl 52 which is swingably pivoted by a pivot pin 51 fixed to these pull brackets 50; a torsion spring 53 (an energizing member) which applies an energizing force to the seizing pawl 52 in the direction of causing the seizing pawl 52 to seize the ratchet 41; and the like.

In the pull brackets 50, a first guide hole 50c which is oblong along the longitudinal direction is formed substantially from the center toward a front end part 50a on the operating handle 30 side, respectively. A shaft pin 22 is inserted into the first guide hole 50c so as to be slidable in a prescribed range. Both ends of the shaft pin 22 are fixed to both sides of the shaft 20. Therefore, the shaft 20 and the pull brackets 50 can be relatively moved in the range that the shaft pin 22 can be moved in the first guide hole 50c.

The shaft pin 22 is loaded with a loose bracket 23. To the loose bracket 23, a spring plate 24a is mounted. Also on the side closer to a releasing pawl 80, later described, a similar spring plate 24b is provided, and between these spring plates 24a, 24b, a coil spring 25 is loaded. Thereby, when a force in the direction of pushing the shaft 20 into the operating handle 30 is applied, the shaft 20 is moved in the direction of the force, but when the coil spring 25 is compressed to absorb the force, and the absorption of the force is terminated, the shaft 20 will be returned to the original position by the resilient force of the coil spring 25.

In addition, in the loose bracket 23, a loose pin 26 extending toward the releasing pawl 80 in the coil spring 25 is fixedly provided. The tip part of the loose pin 26 on the releasing pawl 80 side has a head part with a diameter larger than the shaft diameter of the loose pin 26, and between the head part and the loose bracket 23, a loose spring 27, which is a coil spring with a winding diameter smaller than the diameter of the head part, is loaded so as to wind around the loose pin 26.

The rear end parts 50b of the pull brackets 50 on both sides are connected to each other by means of the pivot pin 51. The seizing pawl 52 is pivoted by the pivot pin 51 substantially in the central part thereof, and as described above, the rear end top part thereof closer to the rear end part 50b of the pull bracket 50 is formed as the pawl part 52a for seizing or releasing the ratchet 41, or butting against the downward slope part 40c or the flat part 40d.

In addition, on the opposite side of the pawl part 52a about the pivot pin 51, a seizing part 52b which is capable of seizing the releasing pawl 80, later described, is formed. The seizing part 52b is formed in such a shape that the tip part is directed downward. In that tip part, when the seizing pawl 52 has been released from the state of seizing the releasing pawl 80, and also has been released from the state of seizing the ratchet 41, a released position maintaining part 52c which is substantially flat so as to be supported, being butted against the tip of the seizing part 81 of the releasing pawl 80, resting thereon, is formed.

In an area more distant from the pivot pin 51, a pin 54 is fixed to the pull brackets 50, and to the pin 54, the torsion spring 53 is loaded. The lower end of the torsion spring 53 is mounted to the pull bracket 50, while the upper end thereof is butted against the seizing pawl 52 from under to apply an energizing force to the seizing pawl 52 in the direction of the pawl part 52a being turned upward to seize the ratchet 41. In an area still more distant from the torsion spring 53, the brake cable 2 is directly connected to the rear end part 50b.

In the rear end part 50b, a space 55 which can accommodate an end piece 2a fixed to the tip of the brake cable 2 is formed.

The releasing mechanism for releasing the seizing pawl 52 from the state of seizing the ratchet 41 comprises the releasing pawl 80 for changing the orientation of the seizing pawl 52 which has seized the ratchet 41, in order to release the seizing pawl 52 from the state of seizing the ratchet 41; a release plate 60 (a fixing member) which extends in the longitudinal direction of the shaft 20, and which the releasing pawl 80 is fixed on the rear end part side thereof, and on the front end part side thereof, a release rod 70 is connected so as to be slidable by a prescribed amount; and the like.

The release plate 60 consists of parallel parts 61 in the shape of a plate that extend parallel with each other in the longitudinal direction of the shaft 20, being in contact with the top and bottom of the pull brackets 50; and an extending part 62 in the shape of a plate that is formed integrally with the upper and lower parallel parts 61 on the front end side and extends in parallel with the side of the shaft 20. In the extending part 62, a second guide hole 63 which is oblong is formed in the direction of the extending part 62 extending. The release plate 60 is disposed such that the extending part 62 is located beyond the front end part 50a of the pull bracket 50, and to the second guide hole 63, said release rod 70 is connected to be slidable.

To the rear end part 60b of the release plate 60, said releasing pawl 80 and the spring plate 24b are fixed. In the releasing pawl 80, the seizing part 81 which can seize (or can be seized by) the seizing part 52b of the seizing pawl 52 is formed. The seizing part 81 is formed in such a shape that the tip part is directed upward. The portions that are brought into contact with each other when the seizing part 81 and the seizing part 52b of the seizing pawl 52 seize each other are formed in such a shape that, when the release plate 60 is moved toward the extending part 62 side, resulting in the releasing pawl 80 being moved in the same direction, the seizing pawl 52 is turned by the releasing pawl 80, which results in the seizing part 81 and the seizing part 52b being released from the state of seizing each other.

The release plate 60 can be moved by operating the operating handle 30 through the release rod 70. The release rod 70 extends to the inside of the operating handle 30. The operating handle 30 is provided with an operating pushbutton 31 for operating the release rod 70, and a link 32 for pulling the release rod 70, being interlocked with the operation of the operating pushbutton 31.

The link 32 has a shape of the sign of inequality “<”, the bent portion being pivoted by a pivot pin. One end part of the link 32 is connected to the tip part 71 of the release rod 70, while the other end part is butted against the operating pushbutton 31. Thereby, operating the operating pushbutton 31 so as to be depressed into the operating handle 30 will turn the link 32 to pull the release rod 70.

By pulling the release rod 70, the pull brackets 50 are moved, and, as mentioned above, the seizing pawl 52 is released from the state of seizing the ratchet 41, thus the shaft 20 can be returned as it is pulled by the brake cable 2, for de-actuation of the brake. In the base bracket 10, a switch 90 and a switch link 91 are disposed in the location where the switch link 91 is butted against the nose part 20b of the shaft 20 when the brake is de-actuated, and the switch 90 can detect the shaft 20 through the switch link 91 butting against the nose part 20b. The switch link 91 is rotatable around a pivot pin 92, being turned by the contact with or the separation from the shaft 20, and the switch 90 can detect the shaft 20, because it is turned ON/OFF through such turning of the switch link 91. With the switch link 91, the length from the center of said pivot pin 92 of the portion of said switch link 91 that is butted against the shaft 20 is longer than that of the portion of said switch link 91 that is butted against the switch 90. By providing the switch link 91, the pressing force for pressing the switch 90 can be set smaller than the pressing force which would be required if the shaft 20 were directly pressed against the switch 90.

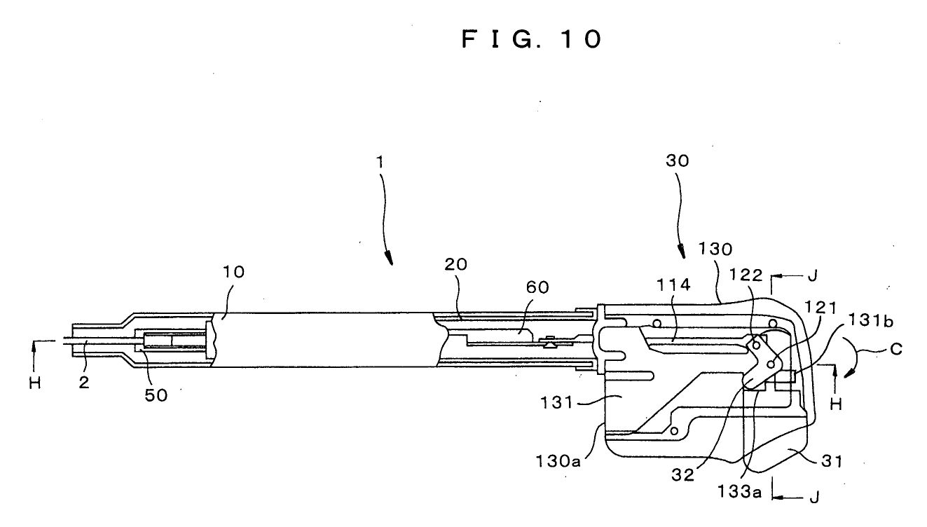

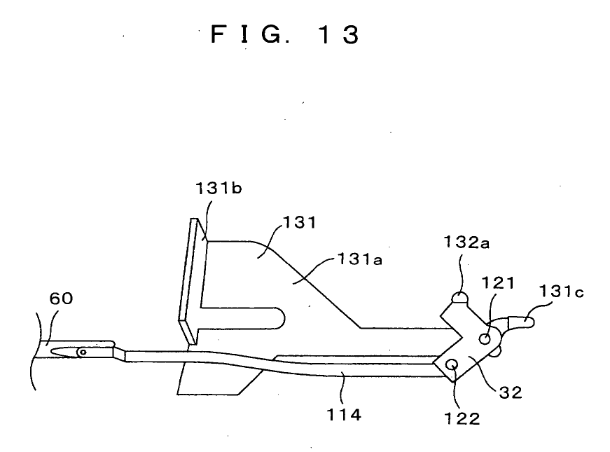

FIG. 10 to FIG. 13 illustrate one embodiment of the operating handle pertaining to the present invention.

As shown in FIG. 10, with a parking brake apparatus 1, a shaft 20 is accommodated inside of a base bracket 10. The shaft 20 is a hollow cylindrical element, made of a metal, and inside thereof, a pair of pull brackets 50 (connecting means) to which a brake cable 2 is connected is provided. In addition, inside the shaft 20, a part of releasing means for canceling the fixed state that the position of the shaft 20 drawn out of the base bracket 10 is fixed, the brake is being actuated, is disposed.

On the other hand, inside of the base bracket 10, fixing means (not shown) for fixing the position of the pull brackets 50 with respect to the base bracket 10 is provided. By using the fixing means to fix the position of the pull brackets 50, the position of the shaft 20 is fixed.

The releasing means is means for releasing the pull brackets 50 from the state of being fixed in position by said fixing means. FIG. 10 shows a part of a release plate 60 which is one of the members constituting the releasing means, being located in the shaft 20, and a release rod 114, one end of which is connected to the release plate 60 and the greater part of which is accommodated in a handle core 130 of an operating handle 30. In the shaft 20, a releasing member (not shown) which constitutes the releasing means, and directly releases the pull brackets 50 from the state of being fixed by the fixing means is disposed.

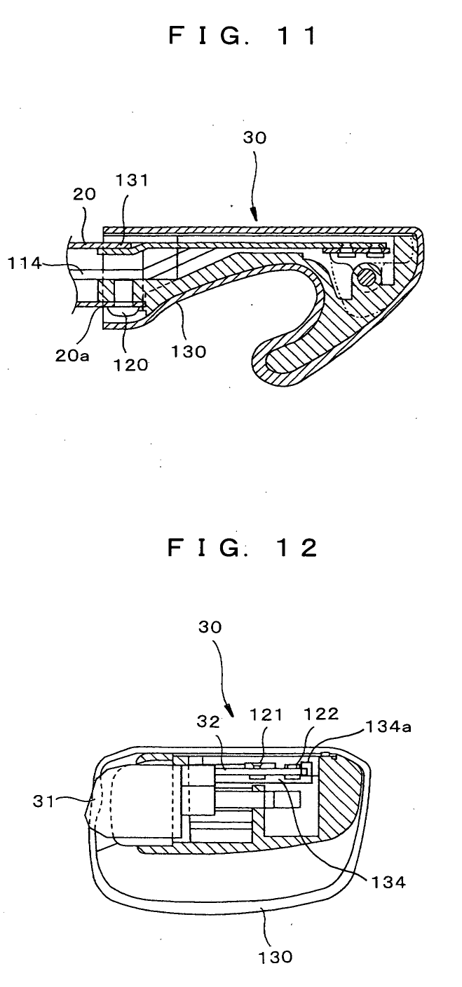

As shown in FIG. 11, the handle core 130 is fixed to a base part 20a of the shaft 20 by means of a bolt 120. In the handle core 130, a shaft plate 131 is disposed.

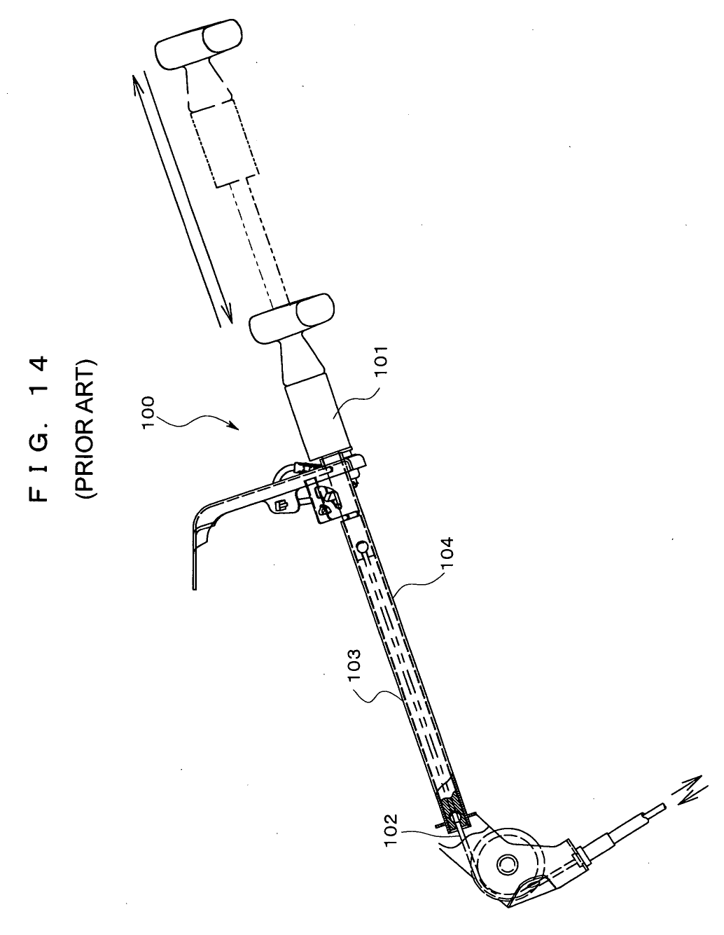

The top surface of the shaft plate 131 is welded to the ceiling surface of the shaft 20 on the base part 20a side. In addition, the shaft plate 131 has a mounting part 131b which is folded substantially at right angles from a flat portion 131a (see FIG. 13). The mounting part 131b is butted against an end face 130a of the handle core 130. The shaft plate 131 has a tip part which is thinned, and in that tip part, a pivot pin 121 is provided. The pivot pin 121 supports a link 32 to be swingable around the pivot pin 121.

In the portion beyond the portion where the pivot pin 121 is mounted, a seizing part 131c which is bent is formed. The seizing part 131c is for preventing a later-described operating pushbutton 31 from being dropped off.

The link 32 has a shape bent in a shape of the sign of inequality “<”, and the bent portion is pivoted by the pivot pin 121. One end part of the link 32 is connected to the tip part of a release rod 114 through a pivot pin 122.

The release rod 114 extends in the handle core 130, being bent, to the inside of the shaft 20, where it is connected to the release plate 60 as mentioned above. In the other end part of the link 32, a butting part 132a which is bent is formed, and against the butting part 132a, an end face 133a of the operating pushbutton 31 is butted.

The operating pushbutton 31 has an arm 134 which extends into the handle core 130. In the tip portion of the arm 134, a dropping-off prevention part 134a which is bent is formed. The operating pushbutton 31 is energized in the direction toward the outside of the handle core 130 by an energizing member (not shown), however, the dropping-off prevention part 134a is seized by the seizing part 131c of the shaft plate 131, thus the operating pushbutton 31 will not be dropped off from the handle core 130.

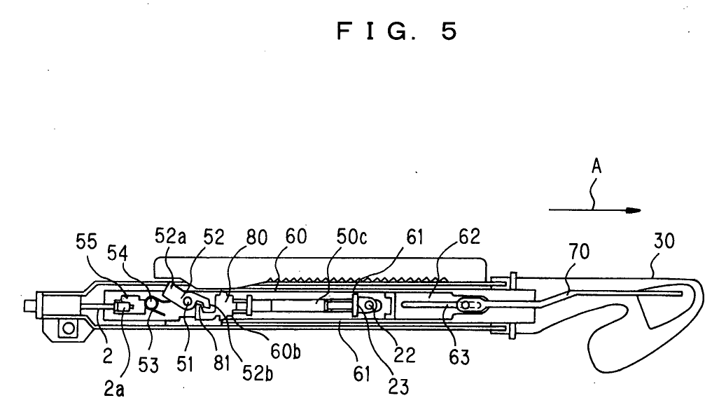

Next, the function of the parking brake apparatus pertaining to the present embodiment will be described. FIG. 4 and FIG. 5 show the parking brake apparatus 1 in the state that it de-actuates the brake.

In this state, the shaft 20 is completely accommodated in the base bracket 10. The pull brackets 50 to which the brake cable 2 is connected and the release plate 60 are positioned in an area which is the closest to the nose part 20b side of the shaft 20. The seizing pawl 52 is positioned in an area more distant from the upward slope part 40e of the ratchet plate 40, being energized upward by the torsion spring 53 from under. Therefore, the seizing part 52b seizes the releasing pawl 80.

In order to operate the parking brake apparatus 1 for actuating the brake, the operating handle 30 is gripped to pull the shaft 20 in the direction of drawing it out of the base bracket 10 (in the direction of arrow A). The frictional force generated between the guide bushing 29 loaded in the nose part 20b of the shaft 20 and the base bracket 10 is low, thus the shaft 20 can be smoothly drawn out of the base bracket 10. Once the shaft 20 is drawn out, and the shaft pin 22 is butted against the end of a first guide hole 50c, the pull brackets 50 are thereafter pulled together with the shaft 20. Thereby, the brake cable 2 is pulled, thus the parking brake apparatus 1 starts to exert the braking force.

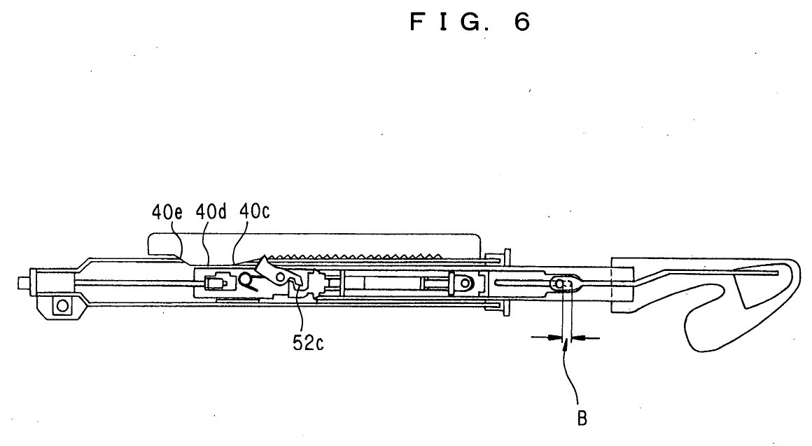

As the pull brackets 50 are pulled, the seizing pawl 52 is butted against the upward slope part 40e of the ratchet plate 40, and further, passing through the flat part 40d and the downward slope part 40c, the seizing pawl 52 reaches the portion where the ratchet 41 is formed (see FIG. 6). After the seizing pawl 52 having reached this area, stopping the pulling of the operating handle 30 will cause the pull brackets 50 to be slightly pulled back by the pulling-back force of the brake cable 2, resulting in the pawl part 52a of the seizing pawl 52 seizing the ratchet 41, which fixes the position of the pull brackets 50. Thereby, the amount of drawing-out of the brake cable 2 is fixed, and the braking force in correspondence to the amount of drawing-out being maintained. In other words, the brake is locked.

In FIG. 6, the dimension as given with a sign of B indicates the stroke (a prescribed amount) by which the release rod 70 is pulled when the operating pushbutton 31 is depressed. The stroke B is for preventing the lock of the brake from being cancelled by a mis-operation of the operating pushbutton 31, and as described later, even if the release rod 70 is merely pulled by the stroke B, the pawl part 52a will not be released from the state of seizing the ratchet 41, and thus the brake will not be released from the locked state.

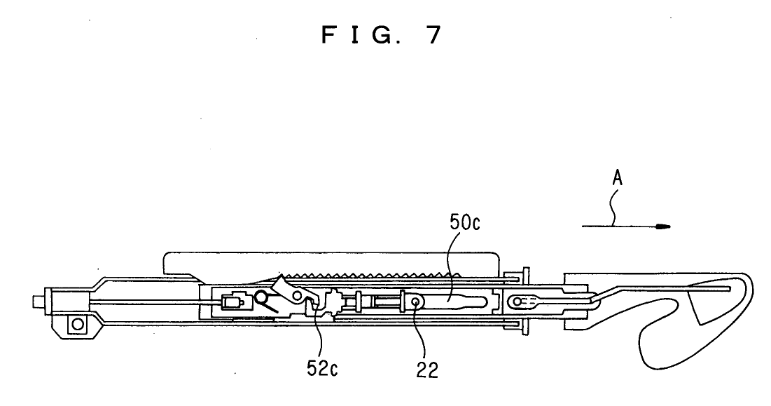

The parking brake apparatus 1 has a cushioning function by which, when a force to push the shaft 20 into the base bracket 10 (a force toward the direction reverse to the direction of arrow A) is applied to the operating handle 30, with the brake being locked, the force is absorbed. FIG. 7 shows the state that the shaft 20 is pushed in by a force toward the direction reverse to the direction of arrow A being applied to the operating handle 30. At this time, because the pawl part 52a keeps seizing the ratchet 41, the position of the pull brackets 50 is not changed. On the other hand, said force is applied to the shaft 20, the shaft pin 22 is slid in the first guide hole 50c toward the rear end part 50b side.

By this sliding, the coil spring 25 loaded between the spring plate 24a and the spring plate 24b is elastically deformed to be compressed. The amount of which the coil spring 25 is compressed is not particularly limited, and it is, for example, approx. 40 mm. The force applied to the operating handle 30 is absorbed by the coil spring 25 being elastically compressed. The cushioning function is activated in this manner, thus even if a driver accidentally hits the knee or some other part of his or her body against the operating handle 30, the degree of injury can be minimized.

When the force applied to the operating handle 30 is removed, the action of the compressed coil spring 25 will return the operating handle 30 to the original position. At this time, an impact sound is generated, resulting from the collision of the members with each other, but the loose spring 27 is elastically deformed, and the impact energy is absorbed by the amount corresponding to the deformation, which results in the impact sound being alleviated.

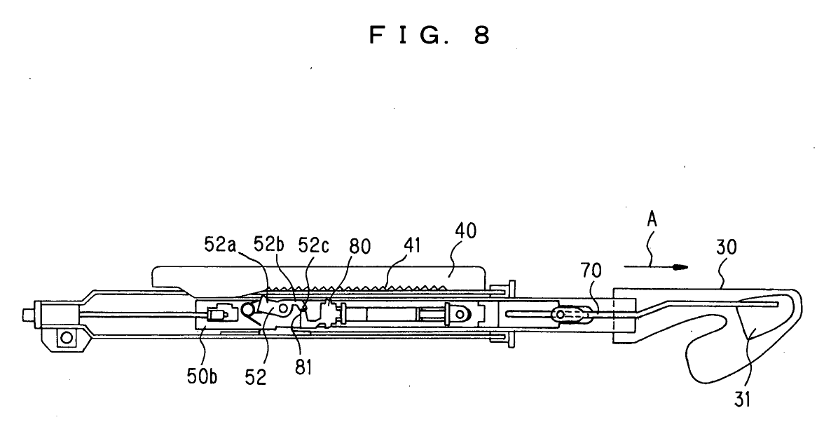

FIG. 8 illustrates the operation when the parking brake apparatus 1 is released from the locked state. When the lock is to be released, the operating handle 30 is pulled in the direction of arrow A from the locked state as shown in FIG. 6, and then the operating pushbutton 31 is depressed by finger. The amount of which the operating handle 30 is to be pulled is, for example, 5 mm or so. With said stroke B being zeroed by pulling the operating handle 30, the force of the brake cable 2 to pull back the pull brackets 50 is cancelled.

In this state, depressing the operating pushbutton 31 will cause the release rod 70 to be pulled in the direction of arrow A through the link 32, with the release plate 60 connected to the release rod 70 being also pulled in the same direction. Thereby, the releasing pawl 80 is moved in the same direction, and the state of the seizing part 52b of the seizing pawl 52 seizing the seizing part 81 of the releasing pawl 80 is cancelled as illustrated, with the pawl part 52a being released from the state of seizing the ratchet 41 of the ratchet plate 40. At this time, the released position maintaining part 52c is supported, being butted against the seizing part 81, resting thereon, thus even if the finger is released from the operating pushbutton 31, the state that the ratchet 41 has been released from the seizing of the pawl part 52a is maintained. In this state, the pawl part 52a is not in contact with the ratchet 41, thus there is no possibility of the pawl part 52a and the ratchet 41 mutually wearing off during the shaft 20 being returned.

Then, as the shaft 20 is accommodated in the base bracket 10 in accordance with the force of the brake cable 2 to pull back, the pawl part 52a is butted against the downward slope part 40c, the flat part 40d, and the upward slope part 40e in this sequence, while being returned to the state as shown in FIG. 5 together with the pull brackets 50, the braking force of the parking brake apparatus 1 being cancelled. When the pawl part 52a reaches the downward slope part 40c, the seizing pawl 52 is reoriented in the direction of separating the released position maintaining part 52c from the releasing pawl 80, and the maintaining of the released position is cancelled. This state is also maintained while the pawl part 52a is being butted against the portion to the flat part 40d. Thereby, the shaft 20 can be smoothly returned without the released position maintaining part 52c and the seizing part 81 being brought into the seizing state. The seizing pawl 52 is energized by the torsion spring 53 in the direction of the released position maintaining part 52c and the seizing part 81 mutually seizing, thus when the pawl part 52a reaches the upward slope part 40e, the released position maintaining part 52c and the seizing part 81 will mutually seize in accordance with the slope of the upward slope part 40e. In the state that the shaft 20 is fully returned, the released position maintaining part 52c and the seizing part 81 fully seize each other.

The shaft 20 which has been fully accommodated in the base bracket 10 is detected by it being butted against the switch link 91 to turn the switch link 91 for turning the switch 900N.

Next, the function of the operating handle pertaining to one embodiment of the present invention will be described.

When the brake in the parking brake apparatus 1 is to be actuated, the operating handle 30 is operated by gripping the handle core 130 fixed to the base part 20a of the shaft 20 and pulling it. Thereby, the shaft 20 is drawn out of the base bracket 10.

The brake cable 2 is connected to the pull brackets 50 disposed inside of the shaft 20, thus when the shaft 20 is drawn out, the brake cable 2 is also pulled. The brake cable 2 is connected to a brake unit (not shown), and as the amount of the brake cable 2 being pulled is increased, the braking force of the brake unit is also increased.

When the pulling handgrip is loosened in the state that the shaft 20 has been drawn out of the base bracket 10, the operating handle 30 is slightly pulled back by the pulling-back force of the brake cable 2. Thereby, the fixing means fixes the position of the pull brackets 50, and the shaft 20 is also fixed firmly. Once the position of the pull brackets 50 is fixed, the brake cable 2 is kept being pulled, and thus the brake unit is locked, being kept exerting the same braking force as that at the time when the brake unit has been locked.

When the brake unit is to be released from the state that the braking force is locked, the operating handle 30 is slightly pulled without turning the shaft 20, and the operating pushbutton 31 is depressed toward the inside of the handle core 130. With the operating pushbutton 31 being depressed, the link 32 is pushed by the operating pushbutton 31 to be turned around the pivot pin 121 in the direction of arrow C.

By this turning of the link 32, the release rod 114 connected to the link 32 is pulled. With the release rod 114 being pulled, the release plate 60 is pulled, and inside the shaft 20, the releasing means is operated, which can cancel the fixing of the position of the shaft 20 that has been caused by the fixing means.

When the fixed state is cancelled, the shaft 20 is pulled by the brake cable 2 through the pull brackets 50, thus by returning the shaft 20 in accordance with the pulling force, the braking force of the brake unit is nullified to cancel the brake actuation.

Thus, the operating handle 30 can be operated with no need for turning the handle core 130, which eliminates the need for providing a space for turning the handle, minimizing the space requirement for the parking brake apparatus 1.

According to the parking brake apparatus pertaining to the present invention, the seizing and releasing mechanism that the seizing pawl seizes the ratchet of the ratchet plate for maintaining the actuation of the brake, and the releasing mechanism that the state of the seizing pawl seizing the ratchet is cancelled are provided in the shaft, and the shaft is held by the base bracket, being enclosed thereby, thus a compact design can be realized, and when the brake is to be released, there is no need for turning the operating handle, which allows the space requirement to be minimized.

Further, the state of the seizing pawl seizing the ratchet can be cancelled by the two-stage operation consisting of the operation of pulling the operating handle, and the operation of the operating pushbutton in the state that the operating handle has been pulled, thus the release due to a mis-operation can be reliably prevented, resulting in the safety being improved.

In addition, the release rod, which operates the seizing and releasing mechanism, being interlocked with the operation of the operating pushbutton in the operating handle, can perform only sliding within a prescribed amount, and will not move the release pawl, if only the operating pushbutton is operated, thus the brake will not be accidentally released, which leads to the improvement of the safety.

In addition, the switch for detecting whether the shaft is fully accommodated in the base bracket is turned ON or OFF through the switch link, thus the pressing force to press the switch can be adequately set, which widens a choice of types of switch available.

In addition, the brake cable can be introduced into the base bracket through the cable introducing slit formed in the rear part of the base bracket, thus the connection can be performed more easily.

In addition, when the state of the seizing pawl seizing the ratchet has been cancelled by the release pawl, the state of the seizing pawl being not in contact with the ratchet is maintained by the release pawl, thus, even if the seizing pawl is moved together with the shaft when the brake is to be released, there is no possibility of a friction being generated between the seizing pawl and the ratchet, which can prevent wearing-off between them, leading to the maintenance being improved.

In addition, according to the parking brake apparatus pertaining to the present invention, the hollow shaft is accommodated inside the base bracket, and further the seizing and releasing mechanism to which the brake cable is connected, and which can fix the position of the shaft with respect to the base bracket by seizing the ratchet provided on the base bracket side, and the releasing mechanism which releases the seizing and releasing mechanism from the state of seizing the ratchet are both disposed in the hollow shaft, thus the entire parking brake apparatus can be made compact, resulting in the space requirement being able to be minimized.

In addition, the guide bushing provided in the nose part of the shaft prevents the shaft from being directly contacted with the base bracket, thus the shaft can be moved smoothly.

In addition, when a force in the direction of pushing the shaft is applied to the operating handle, the shaft can get away in the direction of the force, thus the parking brake apparatus can be prevented from being damaged by the force, and if a person hits the operating handle, resulting in said force being generated, the impact imposed on the person can be minimized.

Further, the shaft which has been subjected to get away by said force, can be returned to the original position by the resilient force of the coil spring.

Further, according to the operating handle pertaining to the present invention, the operating pushbutton provided in the handle core can be operated to operate the release rod, through the link, for operating the releasing means, thus a parking brake apparatus that there is no need for turning the handle to release the brake, i.e., no need for the space for turning it can be realized.

In addition, the seizing part of the shaft plate seizing the dropping-off prevention part which is formed on the arm of the operating pushbutton can prevent the operating pushbutton from being dropped off from the handle core.

The disclosures of Japanese Patent Applications No. 2004-276112, filed on Sep. 22, 2004, No. 2004-276113, filed on Sep. 22, 2004, No. 2004-276114, filed on Sep. 22, 2004, No. 2004-276115, filed on Sep. 22, 2004, No. 2005-225457, filed on Aug. 3, 2005, No. 2004-225458, filed on Aug. 3, 2005, are incorporated in the application.

While the invention has been explained with reference to the specific embodiments of the invention, the explanation is illustrative and the invention is limited only by the appended claims.

What is claimed is:

1. A parking brake apparatus, comprising:
an operating handle including an operating pushbutton;
a base bracket including a ratchet plate having a ratchet;
a brake cable for actuating a brake when the operating handle is pulled along a longitudinal direction of the base bracket; and
a shaft retained in the base bracket and having a base end part fixed to the operating handle and a nose part connected to the brake cable, said shaft including a seizing and releasing mechanism connected to the brake cable and having a seizing pawl for seizing and releasing the ratchet, and a releasing mechanism connected to the operating handle and having a release pawl for reorienting the seizing pawl seizing the ratchet through the operating pushbutton to release the seizing pawl from the ratchet.

2. The parking brake apparatus according to claim 1, wherein said seizing and releasing mechanism further includes an energizing member for applying an energizing force to the seizing pawl in a direction that the seizing pawl seizes the ratchet.

3. The parking brake apparatus according to claim 1, wherein said releasing mechanism further includes a release rod connected to the operating pushbutton for moving the release pawl to reorient the seizing pawl so that the release rod is moved to reorient the seizing pawl for releasing the seizing pawl from the ratchet when the pushbutton is operated in a state that the operating handle is pulled.

4. The parking brake apparatus according to claim 1, wherein said seizing and releasing mechanism further includes a pull bracket extending in a longitudinal direction of the shaft and connected to the brake cable, a pivot pin fixed to the pull bracket for supporting the seizing pawl to be rotatable, and an energizing member for applying an energizing force to the seizing pawl in a direction that the seizing pawl seizes the ratchet; and said releasing mechanism further includes a release rod connected to the operating pushbutton, and a fixing member extending in the longitudinal direction of the shaft and having one end part fixed to the release pawl and the other end part connected to the release rod so that the release rod slides by a prescribed amount, said fixing member being arranged to be able to slide in accompany with the pushbutton when the release rod slides by the prescribed amount so that the release pawl reorients the seizing pawl to release the seizing pawl from the ratchet when the fixing member moves.

5. The parking brake apparatus according to claim 1, further comprising a pivot pin situated close to the nose part of the shaft when the brake is released, a switch link rotatably supported on the pivot pin to be capable of abutting against the shaft, and a switch to be turned on and off with the switch link; said switch link having a first length from the pivot pin to a first portion thereof abutting against the nose part greater than a second length from the pivot pin to a second portion thereof contacting the switch when the brake is released so that the switch is operated with a pressing force smaller than a pressing force of the shaft.

6. The parking brake apparatus according to claim 1, wherein said base bracket includes two bracket members jointed together, a cable introducing slit extending in the longitudinal direction of the base bracket at an end part thereof closer to the nose part of the shaft, and a fixing part for fixing the bracket members.

7. The parking brake apparatus according to claim 2, wherein said seizing pawl includes a released position maintaining part supported on the release pawl for maintaining the seizing pawl at a released position when the seizing pawl is released from the ratchet.

8. The parking brake apparatus according to claim 7, wherein said ratchet plate includes a position canceling part for reorienting the seizing pawl in a direction that the released position maintaining part moves away from the release pawl to release the seizing pawl from the released position.

9. A parking brake apparatus, comprising:
an operating handle including an operating pushbutton;
a base bracket including a ratchet plate extending in a longitudinal direction thereof and having a ratchet;
a brake cable for actuating a brake when the operating handle is pulled along the longitudinal direction of the base bracket;
a shaft with a hollow body retained in the base bracket and having a base end part fixed to the operating handle and a nose part connected to the brake cable;
a seizing and releasing mechanism disposed in the hollow body and connected to the brake cable for seizing and releasing the ratchet to fix the shaft;
a releasing mechanism disposed in the hollow body and connected to the operating handle for releasing the seizing and releasing mechanism from the ratchet; and
a guide bushing fixed to the seizing and releasing mechanism for holding the shaft so that the shaft moves smoothly in the base bracket, and for releasing the shaft in a direction when the shaft is pushed into the base bracket in the direction in a state that the shaft is fixed.

10. The parking brake apparatus according to claim 9, wherein said seizing and releasing mechanism further includes a pull bracket extending inside the shaft in the longitudinal direction, arranged to be movable in the longitudinal direction, and having a rear end part connected to the brake cable, a seizing pawl rotatably supported on a pivot pin fixed to the pull bracket and facing outside the shaft for seizing and releasing the ratchet, and an energizing member for applying an energizing force to the seizing pawl so that the seizing pawl seizes the ratchet; and said releasing mechanism further includes a release pawl for moving the seizing pawl against the energizing force so that the seizing pawl is released from the ratchet.

11. The parking brake apparatus according to claim 9, wherein said seizing and releasing mechanism further includes a coil spring connected to the shaft and extending and being compressed in accompany with the shaft so that the shaft slides in a prescribed range in the longitudinal direction of the base bracket, said coil spring being compressed to absorb a force and return the shaft when the force is applied to the shaft to be pushed into the base bracket in a state that the seizing and releasing mechanism seizes the ratchet and the shaft is fixed.

12. An operating handle for a parking brake apparatus, comprising:
a base bracket;
a shaft accommodated in the base bracket;
connecting means disposed in the shaft for connecting a brake cable;
releasing means disposed in the shaft for releasing the shaft from a fixed position where the shaft is drawn out of the base bracket to actuate a brake so that the shaft returns into the base bracket to release the brake without turning the shaft;
a shaft plate fixed to a base part of the shaft;
a link rotatably supported on the shaft plate with a pivot pin and having one end part connected to the releasing means;
an operating pushbutton connected to the other end part of the link; and
a handle core for accommodating the shaft plate, the link, and the operating pushbutton at a side of the link so that the releasing means is operated through the link to release the shaft when the operating pushbutton is operated.

13. The operating handle according to claim 12, wherein said operating pushbutton includes an arm extending into the handle core and having a bent dropping-off prevention part, said shaft plate including a seizing part for seizing the dropping-off prevention part to prevent the operating pushbutton from coming off from the handle core.
